(19) United States
(12) Patent Application Publication
(10) Pub. No.: US 2024/0085890 A1
(43) Pub. Date: Mar. 14, 2024

(54) Method and System for Measuring Components and Program

(71) Applicant: Carl Zeiss Industrielle Messtechnik GmbH, Oberkochen (DE)

(72) Inventors: Günter Haas, Aalen (DE); Florian Dotschkal, Abtsgmünd (DE)

(21) Appl. No.: 18/450,860

(22) Filed: Aug. 16, 2023

Related U.S. Application Data
(63) Continuation of application No. PCT/EP2022/053666, filed on Feb. 15, 2022.

(30) Foreign Application Priority Data
Feb. 16, 2021 (EP) 21157400.9

(51) Int. Cl. G05B 19/418

(52) U.S. Cl. CPC G05B 19/41875

(57) ABSTRACT

A method for measuring components produced by a production device includes selecting components to be measured from multiple components. The selection is made according to at least one selection parameter. The at least one selection parameter includes a sampling frequency. The method includes determining at least one production parameter. The at least one production parameter includes a production condition. The method includes adapting the sampling frequency based on the production parameter or a change in the production parameter. Adapting includes reducing the sampling frequency in response to one or more production parameters not changing by more than a predetermined amount.

### FIELD

The present disclosure relates to measurement technology and more particularly to measurement of production parts.

### BACKGROUND

Monitoring the quality of components is regularly important within the industrial manufacture of components or workpieces, firstly to ensure quality assurance but also to detect possible production defects in a timely fashion. However, monitoring quality requires a certain amount of time and can thus reduce the production yield.

The test plan for the quality assessment comprises the definition of one or more of the following aspects: test features, test procedure, test frequency (sampling frequency), test method, test means, test data processing.

The test plan for assessing a design may comprise, in particular, the analysis of test features for the purpose of deriving measurement tasks for individual measurement elements, which may be shaped elements, especially shaped elements to be probed. This analysis may comprise the selection of shaped elements that are required for the analysis of the test feature, an analysis of the connection between these shaped elements, the derivation of measurement elements from these shaped elements, and the formulation of the measurement task on the shaped elements/measurement elements. Measurement procedure planning and the creation of a probing and evaluation strategy can then be implemented on the basis of this analysis.

By way of example, a test feature can be a diameter of a drilled hole in the component, with the measurement element then possibly being a cylinder surface of the drilled hole. Then, a number and distribution of measurement points on/at a measurement element can be defined by the probing strategy, for example measurement points along a circular line along the cylinder surface.

If a test criterion, in particular a test feature-specific test criterion, has been satisfied, then the component may pass the quality control or a part of the quality control. By way of example, the criteria test criterion might be satisfied if the diameter of the drilled hole does not deviate from a predetermined target value by more than a predetermined amount. One form of quality control may for example be based on a manual definition of test criteria by a user, for example on the basis of empirical values from the user.

The practice of adapting a production process on the basis of measured dimensions of features of a workpiece is also known. By way of example, this is disclosed in WO 2019/122821 A1, the teaching of which relates to the production and the measurement of workpieces or components.

DE 102 42 811 A1 has disclosed a quality assurance method, wherein error messages and/or alerts are output if stored actual values, measured on assemblies, deviate from specific target values.

Likewise known from the prior art is EP 19 215 250.2, which has not yet been published and which discloses a coordinate measurement method for a plurality of workpieces and a coordinate measuring machine, wherein at least one unstable test feature and at least one stable test feature are determined or assumed and a plurality of workpieces are measured, with the at least one unstable test feature being measured more frequently than the at least one stable test feature.

Further, US 2016/349736 A1 is known, disclosing the metrological sampling method with a sampling rate decision scheme. In particular, a metrological sampling method for reducing and automatically setting a workpiece sampling rate is disclosed.

US 2005/021272 A1 discloses a method and device for carrying out a metrological assignment on the basis of a fault detection analysis.

U.S. Pat. No. 6,687,561 B1 discloses a method and device for determining a sampling plan on the basis of defects.

### SUMMARY

In general, when assessing the quality of a plurality of components, the question arises as to how many of these components and which test features of these components have to be tested in order to allow the quality assurance to be reliable but, simultaneously, require little time.

The technical problem arising is that of developing a method and a system and a program for measuring components, which enable a reliable quality assessment while simultaneously reducing the time required for the quality assessment.

The solution to the technical problem is provided by the subject matter having the features of the independent claims. Further advantageous configurations of the invention are evident from the dependent claims.

A method for measuring components, which is to say a multiplicity of components, is proposed. The method renders it possible in particular to determine or change a measurement strategy for measuring the components and to then carry out the further measurement in accordance with the determined/changed measurement strategy.

The components are produced by a production device. In particular, the production device can be or comprise a manufacturing or machining device. Consequently, the production device can carry out at least one production and/or machining step during the production of the component. A component can also be a workpiece within the meaning of this invention.

The method comprises the selection of components to be measured from a multiplicity of components. By way of example, the selection can be made from one or more batches of components, with a batch comprising a predetermined multiplicity of components which for example were produced under the same production conditions. However, the selection can also be made from a multiplicity of components produced in series production. In particular, the multiplicity of components may comprise more than 10, more than 50, or more than 100 components.

The selection is made in accordance with at least one selection parameter. This may mean that the selection is characterized by at least one selection parameter. As still explained in detail hereinbelow, such a selection parameter may be a sampling frequency, for example. The selection parameter may also be an ordinal number in a sequence of components. The selection parameter can define how many components and optionally also which components from the multiplicity of components should be measured.

The measurement of the components may serve for quality control/assessment in a production process. In particular, a check can be carried out for each selected component as to whether at least one quality criterion has been satisfied. In this context, the components may each comprise or have at least one test feature. Further, a component can be measured and tested in accordance with a test plan, wherein the quality assessment is implemented on the basis of the measurement data created pursuant to the test plan. In this case, at least one test criterion for the quality assessment may be defined by the test plan. A test criterion may be a test feature-specific test criterion. By way of example, a test as to whether a test feature has a target property, for example a target dimension, or does not deviate from the target property by more than a predetermined amount can be carried out during the evaluation of a test criterion. The test criterion may be satisfied in this case. A component may pass the quality assessment if all or a predetermined number of the test criteria are satisfied for the component, which is to say for example if one or more properties determined by the measurement do not deviate from (a) predetermined target property (properties) or do not deviate therefrom by more than a predetermined amount. The component does not pass the quality assessment if this is not the case.

The method may further comprise the creation of component-specific measurement data by measuring the selected components using a coordinate measuring machine and the analysis or evaluation of these measurements data.

In this context, a coordinate measuring machine may comprise at least one sensor for creating the measurement data. The sensor may be a tactile or optical sensor, or any other sensor. Such coordinate measuring machines and sensors for creating measurement data during a measurement are known to a person skilled in the art. In this case, a (component-specific) test plan may define which measurement points should be measured to create the component-specific measurement data, or at which measurement points measurement data are created.

The measurement data can be evaluated in order to determine whether one or more test criteria of the quality assessment have been satisfied by the component. Additionally, the evaluation of the measurement data can be carried out to determine a component-specific property, for example a variable, more particularly a dimension, of a test feature. The measurement data can also be evaluated in order to determine a resultant property for one or more component-specific variables of a plurality of components. By way of example, there can be a statistical evaluation as result of the evaluation of the measurement data, with a statistical variable, for example a mean or scatter of a component-specific property, being determined for a plurality of components. These component-specific properties, the resultant property or the result of the evaluation of the test criteria and/or a result of a quality assessment can be a result of the evaluation.

Further, the adaptation of the at least one selection parameter is made on the basis of the result of the evaluation. This adaptation can also be referred to as an adaptation by closed-loop control in accordance with a small or internal control loop. By way of example, the selection parameter can be set to a predetermined value or changed in a predetermined way if a predetermined result of the evaluation is determined. In this context, there can be a result-specific adaptation. By way of example, a specific result may be assigned a predetermined value of the selection parameter or a predetermined change of the selection parameter, for example an increase or reduction.

What advantageously arises as a result is that the selection is adapted to the properties of the produced components. In turn, this makes it possible to reduce the amount of time required for the quality assessment of the multiplicity of components. By way of example, if it should be determined that the properties of all selected components or of a plurality of selected components either correspond to predetermined properties or deviate therefrom by no more than a predetermined amount, then a selection parameter may be adapted, for example the sampling frequency may be reduced. The selection parameter can also be adapted if a resultant property corresponds to a predetermined target value or deviates therefrom by no more than a predetermined amount. The selection parameter can also be adapted if all selected components or a plurality of selected components pass a quality assessment.

Further a production parameter is determined. The production parameter represents a production condition. Production parameters are still explained in detail hereinbelow. Further, the adaptation of the at least one selection parameter is alternatively, or cumulatively, implemented on the basis of the production parameter or change in the production parameter. In particular, it is consequently no longer necessary to select each component and measure it for quality assessment purposes following a change of a production parameter. This adaptation can also be referred to as an adaptation by closed-loop control in accordance with a large or external control loop.

This production parameter-related adaptation can be implemented with a time offset. By way of example, the selection parameter can be adapted at a time when the first component which was produced using the production parameter determined according to the invention is measured or made available for measurement. In other words, it is therefore possible for the necessity of an adaptation to be detected on the basis of the production parameter or its change, with the adaptation only being implemented after a predetermined time period following the detection of the necessity, which is to say not immediately in particular. By way of example, this time period may be equal to the time period between the completion of the production of one component, in particular using the production parameter or changed production parameter, and a subsequent measurement by the coordinate measuring machine or a subsequent selection of the component for measurement purposes. By way of example, it is possible to produce one or more components with at least one production parameter during a production, wherein the selection of components to be measured from this set of produced components according to the at least one selection parameter, which is adapted in production parameter-related fashion, is only made after a predetermined time period following the completion of this production, wherein the component(s) is/are temporarily stored and/or transported, for example, during the predetermined time period, for example from the production device to the coordinate measuring machine. This enables a spatial separation of production device and coordinate measuring machine, for example at different locations within factory premises or on different factory premises, wherein the selection of the components for the measurement can nevertheless be made in a manner adapted to the production conditions.

Thus, in particular, the adaptation can be implemented if at least one production parameter adopts a specific value or changes by more than a predetermined value. This value or the predetermined amount can be a parameter-specific value a parameter-specific amount. It is possible that there is no adaptation of the production parameter if a production parameter does not change or if the change in the production parameter is less than or equal to a predetermined amount.

In other words, a production parameter or its change therefore has an effect on the selection process for components to be tested. By way of example, it is thus possible to increase the sampling frequency if a production parameter changes, especially in a predetermined way.

There can also be a further selection of components to be measured in accordance with the adapted selection parameter. In particular, the selection can be made in accordance with the adapted selection parameter immediately following the adaptation of the selection parameter.

Prior to the first adaptation, the selection can be made in accordance with at least one predetermined initial selection parameter. The latter may be specified for example by a user, for example on the basis of empirical knowledge. Alternatively, each component can be selected prior to the first adaptation. Hereafter, the adaptation can then be implemented continuously, which is to say repeatedly. Thus, the selection parameter is consequently subjected to closed-loop control.

As a result, it is possible to ensure that a reliable but at the same time quick quality assessment is carried out for components produced under changed production conditions, as a result of which, in particular, it is also possible to increase the yield of components which are produced within a predetermined time period and for which the quality requirements can be assumed to be fulfilled. This may also change the specification as to how many and optionally also which components of the multiplicity of components should be measured for reliable quality assessment. The closed-loop control likewise enables dynamic adaptation, which quickly and reliably adapts the quality assessment process to changed production conditions and/or current component properties.

For example, it is possible to increase or reduce the sampling frequency in the case of certain changes of certain production parameters. However, if there is no change in the production conditions, it is possible to leave the sampling frequency at the set value or, depending on the results of the evaluation, optionally reduce it, which can then in turn reduce the time period of a reliable quality assessment. In other words, it is thus conceivable for the at least one selection parameter to be adapted in such a way that fewer components to be measured are selected than before the adaptation if one or more production parameters, in particular selected production parameters, do not change or do not change by more than a predetermined amount, especially during a predetermined time period. This can be implemented in particular by a reduction in the sampling frequency. In particular, such an adaptation can be implemented if, additionally, the evaluation of the measurement data created during the measurement of the components produced with this production parameter/these production parameters yields that the properties of the components selected prior to the adaptation correspond to predetermined properties or do not deviate therefrom by more than a predetermined amount.

In a further embodiment, at least one measurement parameter is determined, the at least one selection parameter being adapted on the basis of the measurement parameter or a change in the measurement parameter. A measurement parameter may represent measurement conditions when measuring the component. By way of example, such a measurement parameter may represent a utilized sensor or a testing means used for the measurement. The measurement parameter can also be a measurement temperature. In this case, the explanations regarding the adaptation of the selection parameter on the basis of the production parameter also apply in corresponding fashion to the adaptation of the selection parameter on the basis of the measurement parameter. For example, it is possible to increase or reduce the sampling frequency in the case of certain changes of certain measurement parameters. For example, if a sensor used for the measurement is replaced by a less accurate sensor, then the sampling frequency can be increased. However, if there is no change in the measurement conditions, it is possible to leave the sampling frequency at the set value or, depending on the results of the evaluation, optionally reduce it, which can then in turn reduce the time period of a reliable quality assessment.

In an embodiment, the at least one selection parameter is adapted in partly or fully automated fashion. Fully automated can mean, in particular, that the adaptation is implemented without a user interaction, for example a user input, further without a user confirmation or input of a value for the selection parameter, for example. In particular, it is possible for the selection parameter to be adapted by an artificial system or by an artificial intelligence method.

It is also conceivable for there to be a partly automated adaptation of the selection parameter. In this case, a selection parameter can be determined without any user input or interaction and proposed to a user for confirmation, for example using a suitable output device. The user can then prompt the adaptation of the selection parameter by virtue of confirming the proposed selection parameter, for example by operating a suitable input device.

By way of example, the selection parameter intended for adaptation can be determined by evaluating a certain mapping between the result of the evaluation and/or production parameter and/or its change and a selection parameter or by evaluating a predetermined mapping between the result of the evaluation and/or production parameter and/or its change to a change in the selection parameter.

This/these predetermined mapping(s) can be evaluated by way of a suitable evaluation device, for example, and the adaptation is implemented by virtue of using the selection parameter arising from the mapping or changing a currently set selection parameter in accordance with the change arising from the mapping.

This advantageously yields a quick and reliable adaptation of the selection parameter, especially to changing production conditions and/or to properties of the components. This in turn enables a reliable quality assessment that requires little time.

The selection parameter is adapted on the basis of rules in a further embodiment. By way of example, a rule-based adaptation can be implemented by virtue of predetermined rules being evaluated, especially by data processing methods. In this case, the result of the evaluation, explained above, and/or a production parameter and/or a change in a production parameter may form an input variable for the rule. The output variable of the rule can be the at least one selection parameter to be set by the adaptation, or the change in the selection parameter.

Thus, a rule may represent a relationship between exactly one input variable or more than one input variable and exactly one output variable or more than one output variable.

The rule consequently forms a mapping between at least one input variable and the at least one selection parameter or a change in the at least one selection parameter.

In this case, it is possible for a rule to be user-specified. In particular, a rule can be specified by a user who may resort to empirical values, for example, to this end. By way of example, the rule can then be defined by an appropriate user input. In other words, expert knowledge can be reflected by rules.

Alternatively, a rule may be determined on the basis of an evaluation, in particular an interpretation, of measurement and production data. In particular, statistical data evaluation methods can be applied to a data set comprising measurement and production data in order to identify relationships, in particular a relationship between a change in a production condition and a change in the result of the evaluation of the measurement data. In particular, statistical characteristics can be determined and used to determine the rules. To this end, the data set may also comprise the result of the evaluation. The statistical methods may in particular comprise or apply a method for data compression.

A user-specified rule, or a rule determined by evaluation, can be stored, for example in a storage device of a system for measuring components. Further, the stored rule, in particular, can be evaluated by an evaluation and control device of the system.

This enables a determination of rules that is as reliable as possible, in particular on the basis of relationships which are not immediately evident to a user, and therefore also enables an improved adaptation of the selection parameter to changing production conditions and/or properties of the components. In other words, this enables further expert knowledge to be generated in the form of these rules.

In this case, production data can be data that represent the production conditions of the component(s). In particular, production data may comprise or encode one or more production parameters. In particular, it is possible to apply data mining methods in order to derive rules for the rule-based adaptation from already-created measurement and production data.

By way of example, if a change in a production condition, for example represented by the change in a production parameter, leads to a deterioration in the quality of the components produced post-change, which can be determined by the evaluation of the measurement data, then it is possible to define a rule in such a way that the sampling frequency is increased when the change in the production parameter is detected. By way of example, if a change in a production condition, for example represented by the change in a production parameter, leads to an improvement in the quality of the components produced post-change, for example because a worn tool is replaced with a new tool, then it is possible to define a rule in such a way that the sampling frequency is reduced when the change in the production parameter is detected.

The use of rules for adapting the selection parameter advantageously yields an easily implementable adaptation of the selection parameter.

In a further embodiment, rules are determined using machine learning. In this case, the term “machine learning” comprises or denotes methods for determining rules on the basis of training data. Thus, it is possible for rules, in particular in the form of a model, to be determined by supervised learning methods and for the training data, which comprise the input and output variables explained above, to be used to this end. In this case, the input and output variables which form the training data may be specified by a user, for example as input and output variables of the user-specified rules explained above. In an alternative, or cumulatively, the input and output variables of the rules, which are determined by evaluation and explained above, can form the training data or a part thereof.

By way of example, it is possible for the user to define that a specific value of an input variable or a specific change in an input variable leads to a specific value of the output variable or a specific change in the output variable. Further, the training, which is to say the model identification or the identification of one or more rules, can be implemented on the basis of the data provided by a user in this way. However, it is naturally also conceivable that unsupervised learning methods are used to determine the rule.

Suitable mathematical algorithms for machine learning comprise: decision tree-based methods, ensemble methods-based methods (e.g., boosting, random forest), regression-based methods, Bayesian methods-based methods (e.g., Bayesian belief networks), kernel methods-based methods (e.g., support vector machines), instance-based methods (e.g., k-nearest neighbor), association rule learning-based methods, Boltzmann machine-based methods, artificial neural networks-based methods (e.g., perceptron), deep learning-based methods (e.g., convolutional neural networks, stacked autoencoders), dimensionality reduction-based methods, regularization methods-based methods.

It is also conceivable for rules to be determined using a neural network. By way of example, the neural network may be in the form of an autoencoder or in the form of a convolutional neural network (CNN) or in the form of an RNN (recurrent neural network) or in the form of an LSTM network (long short-term memory network) or in the form of a neural transformer network or in the form of a combination of at least two of the aforementioned networks. It is also possible to apply artificial intelligence methods for determining the rules. These are known to those skilled in the art.

This advantageously results in an improved adaptation of the measurement of components to the production conditions, in particular to the development of the production conditions over time, wherein, at the same time, the aforementioned reliability and accuracy of the quality assessment is ensured. Thus, machine learning methods in particular allow the determination of rules which can be derived from relationships, which a user finds very difficult to identify, between the input variables and the output variables as explained above.

It is also possible for the rules to be adapted. This may mean that the rules, in particular at least one rule parameter of a rule, are changed. By way of example, the model explained above may be adapted. In this case, the adaptation may likewise be implemented by machine learning methods. It is also possible for the rules, in particular the model explained above, to be adapted by self-adaptive algorithms.

In this case, it is conceivable that measurement and production data, which also serve as the basis for determining the rules, are evaluated in order to create new rules and/or change existing rules. Machine learning methods can also be used to this end. Additionally, an already trained model can be retrained with newly provided training data, for example in the form of input and output variables of rules determined by evaluation, wherein the rules determined by evaluation are determined by evaluating measurement and production data created with the previous, non-adapted model.

By adapting rules, there is advantageously a permanent, in particular continual adaptation of the measurement to the development over time of the production conditions and/or the properties of the components produced, and, accompanying this, the already mentioned assurance of reliability and accuracy of the quality assessment.

In a further embodiment, a production parameter is or represents an ambient condition. In particular, an ambient condition can be a (production) temperature, a (production) air pressure, a (production) humidity and/or the brightness, which influence the production or are decisive for the production.

Additionally, a production parameter can be or represent a tool used for the production. In this case, a change in the production parameter can be or represent a change of tools. By way of example, a sampling frequency can be reduced if a tool is replaced by a less used tool. Additionally, a sampling frequency can be increased if a tool is replaced by a tool that has been subject to more wear.

Additionally, a production parameter can represent a method used for the production. For example, it is conceivable that a component can be produced by different production methods. For example, a desired surface shape of a (portion of a) component can be produced by a milling method, a grinding method, a planing method or any other manufacturing method. Under certain circumstances, different manufacturing qualities of this surface shape can be attained using the different methods. By way of example, a sampling frequency can be reduced if the production is switched from one manufacturing method to a manufacturing method with a comparatively higher manufacturing quality.

Further, a production parameter can be or represent a number of components produced since a certain time. By way of example, the production parameter can be the number of components produced since the last implemented adaptation of the selection parameter or the number of components produced since the start of production, since the start of a shift, or since the start of production of a batch.

Further, a production parameter can be or represent a production time period since a certain time. By way of example, the production parameter can be the production time period since the last implemented adaptation of the selection parameter or the time period since the start of production, since the start of a shift, or since the start of production of a batch.

By way of example, it is possible for the selection parameter to be adapted, for example for a sampling frequency to be increased, after the production of a predetermined number of components and/or after the expiry of a production time period, in particular, but not necessarily, under constant or approximately constant production conditions. In this case, approximately constant conditions denote conditions that do not deviate from the conditions present at the outset by more than a predetermined amount.

Further, the production parameter can be or represent a number of batches produced since a certain time. In this case, the production parameter can be for example the number of batches produced since the last implemented adaptation or the number of batches produced since the start of production or since the start of a shift. By way of example, there can be an adaptation, for example an increase in the sampling frequency, if a predetermined number of batches of the component have been produced, in particular, but not necessarily, under constant or approximately constant production conditions. In particular, the predetermined number of batches can be 1.

In this case, the start of production, shift or batch can in particular be the start time of the production, shift or batch, during which the components from which a selection should be made in accordance with the selection parameter were produced.

Further, it is possible for a production parameter to represent a shift group or a shift group change, for example an early shift, a normal shift, a late shift, a night shift or any other shift group, or a shift change between these, for example the number of shift changes since the start of production or start of production of a batch or since the shift start of a predetermined shift. In this case, the production parameter can change, for example a sampling frequency can be increased, if a shift change occurs or a plurality of shift changes occur. Consequently, the selection parameter can be adapted when a shift change occurs or a plurality of shift changes occur.

It is further possible for a production parameter to also represent a test means used during or for the production—and consequently prior to the selection and measurement by the coordinate measuring machine—wherein for example the production process is subjected to open-loop or closed-loop control on the basis of test results from the test means.

Further, a measurement parameter can represent a sensor used for the measurement. This has been explained hereinabove.

The listed production parameters advantageously allow a reliable adaptation of the measurement to production conditions, the change of which as a rule has an effect on the production quality of the produced component. For example, it was recognized that a change, in particular a change by more than a predetermined amount, in one or more of the aforementioned ambient variables changes the production quality. For example, it was recognized that an increase in the number of components produced since a certain time or an increasing production time period or an increase in the number of batches produced may have an effect on the production quality, in particular on account of tool wear. By way of example, it is thus possible to increase a sampling frequency in the case of a change that leads to a quality reduction.

However, it was also recognized that changes may also bring about an improvement in the quality. For example, if a more accurate and/or less used tool is used, then this may increase the production quality. By way of example, it is thus possible to decrease a sampling frequency in the case of a change that leads to a quality increase.

It was likewise recognized that the shift group may have an effect on a production quality. Thus, the sampling frequency can be increased in the case of the shift change, in order to ensure that a desired quality is ensured even during the production with the new shift.

In this case, values of production parameters or changes in production parameters which lead to a reduction in the production quality or to an increase in the production quality can be identified by the evaluation of the measurement and production data as explained hereinabove. Further, a reduction or increase or else the value resulting from the reduction or increase may be assigned to a selection parameter, for example in the form of a predetermined mapping. This mapping then allows the determination of the selection parameter which should be used for the adaptation.

In a further embodiment, the selection parameter is a sampling frequency. In this case, the sampling frequency can denote the number of the measured components, measured in particular for the quality assessment, from a predetermined set of components, for example 100, or the set of the components produced within a predetermined time. The greater the sampling frequency, the more time and computational outlay is required for the corresponding measurement and test. However, a higher sampling frequency also increases the reliability of the quality assessment.

The choice of the selection parameter as a sampling frequency advantageously enables an adaptation of the measurement which is very easy to implement while ensuring the desired reliability and accuracy of the quality assessment.

In a further embodiment, the at least one selection parameter or at least one further selection parameter is an ordinal number in a sequence of produced components. By way of example, the sequence can be the sequence of the components produced since the last adaptation of the selection parameter, since the start of production, since the start of the production of the batch, since the start of the shift or since a predetermined time in the past.

It is possible that a plurality of ordinal numbers are defined by a plurality of selection parameters. By way of example, these ordinal numbers can be distributed equidistantly between the first and the last component of the sequence, in particular of the multiplicity of components from which a selection is made. In other words, it is possible for example for each n-th component to be selected, where it is possible for n=1, 2, 3, . . . . However, it is also possible for the ordinal numbers to be distributed unequally over the sequence, which is to say not equidistantly over the sequence between the first and the last produced component. As a result, it is possible for each k-th component to be selected in a first section of the sequence, for example up to a predetermined number of components in the sequence. Then, in a subsequent section, each t-th component can be measured, where t can be different from k, in particular greater than k.

By way of example, this advantageously allows a frequent measurement and quality assessment to be implemented at the start of a production with changed production conditions, whereby the desired reliability and quality of the quality assessment can already be ensured from the start. For example, it may be the case that components produced immediately after the change in production conditions are more susceptible to undesirable quality deviations than components produced at a later time, for example due to transient processes in the corresponding production device.

In a further embodiment, the selection of components to be measured is made from a batch of components. In this case, the sampling frequency may be related to the number of components in a batch, for example. Further, the components to be measured are selected in accordance with the adapted selection parameter from a further batch of components, for example a batch produced at a later time. Thus, this results in a batch-specific selection of components and evaluation of the corresponding measurement data. Thus, there is a batch-specific adaptation of the selection parameter. This advantageously represents a good compromise between the frequency of the adaptation and the desired reliability and accuracy of the quality assessment, especially since the assumption can be made that components of the same batch were produced under approximately the same production conditions.

However, it is naturally also possible for the selection of components to be measured to be made from a (first) subset of components produced during a series production, wherein the selection parameter is then optionally adapted, wherein components to be measured are then selected in accordance with the adapted selection parameter from a further subset of components of this series production, wherein the components of the further subset were produced later than the components of the first subset. This results in a continual or virtually continual adaptation of the measurement, and hence also the quality assessment.

In a further embodiment, at least one quality measure is determined for a plurality, in particular a predetermined number but not all, or each of the components of the selected components by way of the evaluation, with the adaptation of the at least one selection parameter being implemented on the basis of the quality measure or a change in the quality measure. In this case, the quality measure may represent the quality of one or more components. By way of example, the ratio between the number of selected components that passed a quality assessment and the overall number of selected components can be determined as the quality measure.

In particular, the selection parameter can then be adapted in such a way that a reliable quality assessment for the multiplicity of components is ensured by the measurement of the components selected in accordance with the adapted selection parameter and the quality assessment based on this measurement.

By way of example, the sampling frequency can be increased should a quality, which is to say for example a quality represented by the quality measure, have reduced by more than a predetermined amount over a predetermined time period. By way of example, the sampling frequency can be reduced should a quality not have reduced by more than a predetermined amount over a predetermined time period.

This advantageously yields an adaptation of the measurement, in particular of the selection, in such a way that a reliable quality assurance can be implemented with the smallest possible number of components being measured.

In a further embodiment, at least one component-specific property is determined for a plurality or each of the components of the selected components by way of the evaluation, wherein an adaptation is implemented if the component-specific property deviates by more or less than a predetermined amount from a target value, in particular a predetermined target value, for a predetermined number of components, for example for one or more or all components, or if the component-specific property changes by more than a predetermined amount. This deviation or change can be a quality measure. The property can be a variable, in particular

a dimensional variable, for example a dimension of a test feature. In this case, a dimension can be for example a length, a width, a depth, a diameter, a circumference, a distance or a further dimensional variable.

For example, the sampling frequency can be increased if the component-specific property deviates by more than a predetermined amount from the target value in the case of a predetermined number of components or the sampling frequency can be reduced if the component-specific property does not deviate by more than a predetermined amount from a (further) target value in the case of a predetermined number of components.

In an alternative, at least one resultant property is determined on the basis of the component-specific properties which were determined by the evaluation, an adaptation being implemented if the resultant property deviates by more or less than a predetermined amount from a target value, in particular a predetermined target value, or if the resultant property changes by more than a predetermined amount. By way of example, the resultant property can be a mean or a scatter. Additionally, the resultant property can be a frequency of defects in relation to the number of selected components, for example components in a batch. For example, this may specify the number of defective components or faults detected overall in the number of selected components.

More generally, the resultant property can be a statistical variable which represents or characterizes a scatter of the component-specific properties. The resultant property or the deviation of the resultant property from a target value can be a quality measure. For example, the sampling frequency can be increased if the resultant property deviates from the target value by more than a predetermined amount or can be reduced if the resultant property deviates from the target value by less than a predetermined (further) amount.

Advantageously, this results in a change of the measurement of components if properties that are particularly critical to the quality vary by more than a desired amount. In particular, in the alternative scenarios mentioned above, the sampling frequency can be increased and/or an ordinal number or a plurality of ordinal numbers of the components to be selected can be adapted for a subsequent sequence of produced components. If such properties do not vary or vary less than the desired amount, then it is for example possible to reduce the sampling frequency and optionally likewise adapt the ordinal number(s) of the components to be selected. Consequently, there can be a quick reaction to unwanted changes in variables that are critical to the quality, whereby a reliable and accurate quality assessment is ensured in turn.

Following the determination of the at least one production parameter, the selection parameter is set in a further embodiment to a value assigned to the production parameter or to the change in the production parameter. Alternatively, the selection parameter is changed, wherein the change is assigned to the production parameter or to the change in the production parameter. Predetermined mappings or rules can be evaluated to this end. This and corresponding advantages have already been explained hereinabove.

In this case, the adaptation may comprise the determination of a selection parameter or its change. Further, the adaptation may also comprise the change of the currently set value of the selection parameter.

It is also proposed that a purely production parameter-related adaptation of the at least one selection parameter is followed by
a) a selection of components to be measured from a predetermined number of components, the selection being made in accordance with the selection parameter which has been adapted in production parameter-related fashion,
b) a creation of component-specific measurement data by measuring the selected components using a coordinate measuring machine and the evaluation of the measurement data and
c) a renewed, purely result-related adaptation of the at least one selection parameter on the basis of the result of the evaluation.

A purely production parameter-related adaptation in this case denotes an adaptation which is implemented on the basis of the production parameter or a change in the production parameter but not on the basis of the result of the evaluation. Accordingly, a purely result-related adaptation denotes an adaptation which is implemented on the basis of the result of the evaluation but not on the basis of the production parameter or a change in the production parameter.

In other words, the production parameter-related change of the at least one selection parameter is followed by a selection being made using the correspondingly changed selection parameter, and an adaptation on the basis of the result of the evaluation, but not on the basis of the production parameter, is optionally carried out thereafter. In other words, a check can be carried out following a production parameter-related change as to whether a further change in the selection parameter is required in order to ensure the reliable and accurate quality assessment, for example because properties of the components vary in a way which requires a higher sampling frequency for the reliable quality assurance or which allows a lower sampling frequency for an unchanged reliable quality assurance. Advantageously, this allows a reliable and accurate adaptation of the at least one selection parameter.

Further proposed is a program which, when executed on or by a computer, prompts the computer and a coordinate measuring machine to carry out one or more or all of the steps of a method for measuring components in accordance with one of the embodiments explained in this disclosure. In an alternative, or cumulatively, a program storage medium or computer program product, on or in which the program is stored, in particular in a non-temporary, for example permanent, form, is described. In an alternative, or cumulatively, a computer that comprises this program storage medium is described. In a further alternative, or cumulatively, a signal is described, for example a digital signal, which encodes information items representing the program and which comprises coding means adapted to carry out one or more or all of the steps of the measurement method set out in this disclosure. The signal can be a physical signal, for example an electrical signal, which in particular is generated technically or by machine. The program may also prompt the computer to carry out a measurement of a component, in particular a selected component, using the coordinate measuring machine.

Further, the measurement method can be a computer-implemented or at least partially computer-implemented method. For example, one or more or all of the steps of the method, apart from the creation of the measurement data, may be carried out by a computer. One embodiment of the computer-implemented method is the use of the computer for carrying out a data processing method. The computer may for example comprise at least one computing device, in particular a processor, and for example at least one storage device, in order to process the data, in particular technically, for example electronically and/or optically. A computer can in this case be any kind of data processing device. A processor can be a semiconductor-based processor. This advantageously yields a program, whereby the method explained hereinabove with the likewise explained advantages is able to be implemented.

A system for measuring a plurality of components produced by a production device is also proposed. The system comprises at least one coordinate measuring machine and at least one evaluation and control device. In this case, the evaluation and control device may comprise a microcontroller or an integrated circuit, or be embodied as such. The system is configured to carry out a method from one of the embodiments explained in this disclosure. It is possible that the system also comprises the production device.

In this case, the evaluation and control device can be data-connected and/or signal-connected to a control device for controlling the operation of the coordinate measuring machine. The evaluation and control device can also be data-connected and/or signal-connected to the production device.

In this case, the control and evaluation device:
can carry out the selection of components to be measured and the evaluation of the measurement data,
can drive the coordinate measuring machine to create measurement data, and/or
can determine the production parameter and/or its change, and
can carry out the adaptation of the at least one selection parameter.

In this case, the evaluation and control device may consist of a plurality of modules or comprise a plurality of modules or be formed by a plurality of modules. The coordinate measuring machine can be driven on the basis of a test plan.

This advantageously results in the method described in this disclosure being able to be carried out, with the corresponding technical advantages, by the system.

Further, the system may comprise a device for determining a production parameter. For example, this device may be a sensor, by way of example an air pressure sensor, a humidity sensor or temperature sensor. The device for determining a production parameter can also be a device for determining a utilized tool or one of the further production parameters explained hereinabove. This device can be signal-connected and/or data-connected to the control and evaluation device.

Further, the system may comprise an evaluation module, a planning module, and a control module, with the modules being data-connected to one another. In this case, the evaluation module can carry out the evaluation of the measurement data. In this case, a planning module can determine a measurement strategy for measuring the multiplicity of components. In particular, this measurement strategy can define the selection of components to be measured from the multiplicity of components in accordance with the at least one selection parameter. In other words, the measurement strategy defines how frequently, how many and/or optionally also which components should be measured. The measurement strategy can also define how the components are measured. For example, one or more test plans can be part of the measurement strategy. The control module can control a selection device and the coordinate measurement machine in accordance with the measurement strategy defined by the planning module.

A system for producing a component is also described, the system comprising a production device and a system for measuring components in accordance with one of the embodiments described in this disclosure.

### BRIEF DESCRIPTION OF THE DRAWINGS

The invention will be explained in detail on the basis of various embodiments. In the figures:

FIG. 1 shows a schematic flowchart of a method according to the invention for measuring components,

FIG. 2 shows a schematic and non-comprehensive illustration of rules for adapting a selection parameter,

FIG. 3a shows a schematic block diagram for adapting the selection parameter,

FIG. 3b shows a schematic block diagram for adapting the selection parameter,

FIG. 4 shows a schematic illustration of the selection of components to be measured, in accordance with a first embodiment,

FIG. 5 shows a schematic illustration of the selection of components to be measured, in accordance with a further embodiment,

FIG. 6 shows a schematic block diagram of a system according to the invention,

FIG. 7 shows a schematic block diagram of a system according to the invention in a further embodiment, and

FIG. 8 shows a schematic flowchart of a method according to the invention in accordance with a further embodiment.

Elements with identical reference signs hereinafter denote elements having identical or similar technical features.

### DETAILED DESCRIPTION

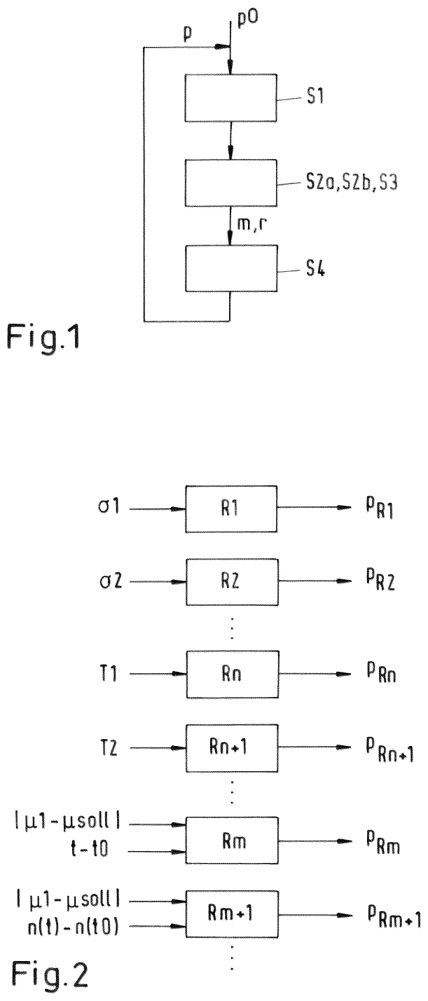

FIG. 1 shows a schematic flowchart of a method according to the invention for measuring components B (see FIG. 4). These components B are produced by a production device 1 (likewise see FIG. 4). The method comprises the selection S1 of components B to be measured from a multiplicity of produced components B. The selection is made in accordance with at least one selection parameter p. FIG. 1 depicts that the selection of components B to be measured is made using a (non-adapted) initial selection parameter p0 at the start of the method, which is to say before the first adaptation.

In particular, the selection parameter p, p0 can be or represent a sampling frequency. It is conceivable that the selection is made in accordance with a plurality of selection parameters p, p0, wherein for example a first selection parameter can be or represent the explained sampling frequency and wherein a further selection parameter can be an ordinal number of a component B to be selected from a sequence of produced components B.

There further is a creation S2a of component-specific measurement data MD by measuring the selected components B using a coordinate measuring machine 2 (for example, see FIG. 4) and the evaluation S2b of these measurement data MD created by the measurement. In this case, it is possible to use different coordinate measuring machines, for example coordinate measuring machines 2 having an optical sensor or coordinate measuring machines 2 having a tactile sensor. Naturally, tomography-based coordinate measuring machines 2 can also be used.

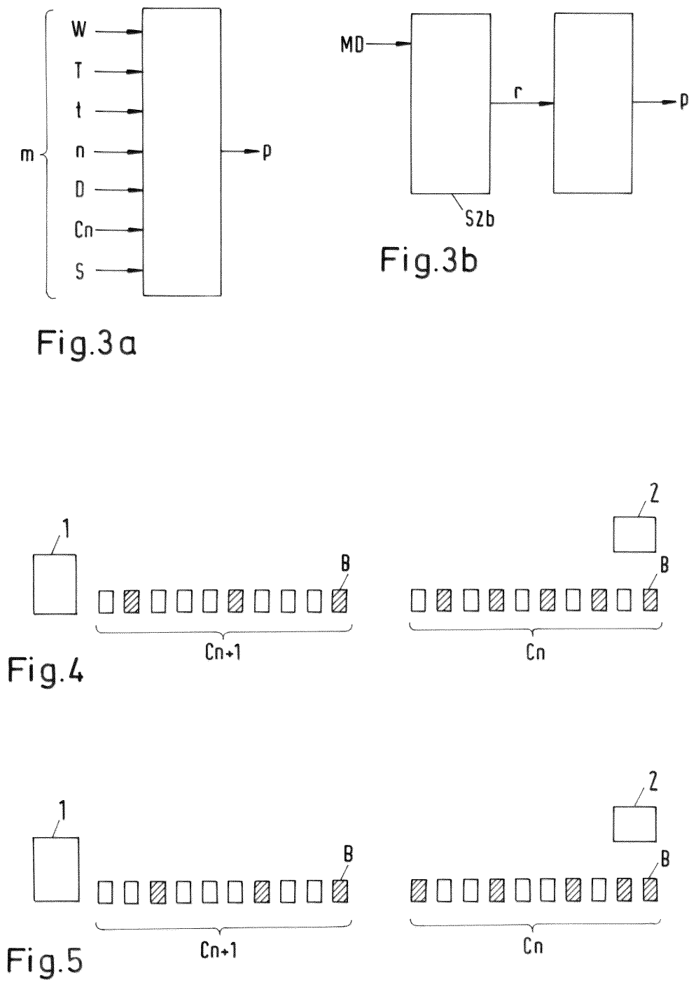

By way of example, by evaluating S2b the measurement data MD (for example, see FIG. 3B), it is possible to determine as a result at least one component-specific property, in particular a dimensional variable. This component-specific variable can be a characteristic of a component-specific test feature, for example a dimensional variable such as a length, a width, a diameter, a depth, a distance from a reference point or reference line, or any further dimensional variable. Further, a component-specific variable which represents the quality of the measured component or the quality of a test feature of the measured component B can be determined by evaluating S2b the measurement data MD.

Further, it is possible that the evaluation S2b of the measurement data MD tests whether the component, the respective measured component B, passes a quality assessment, in particular whether predetermined quality criteria for the component B are satisfied. This quality assessment, in particular the test of the test criteria, can be implemented on the basis of the component-specific properties. Thus, the result r of the evaluation can be the number of components B that have passed the quality assessment.

Further, it is possible for component-specific properties of a plurality or each of the components B of the selected plurality of components B to be determined, wherein then at least one resultant property is determined as result r of the evaluation on the basis of this component-specific property. By way of example, this may be or represent a mean or scatter of the component-specific property.

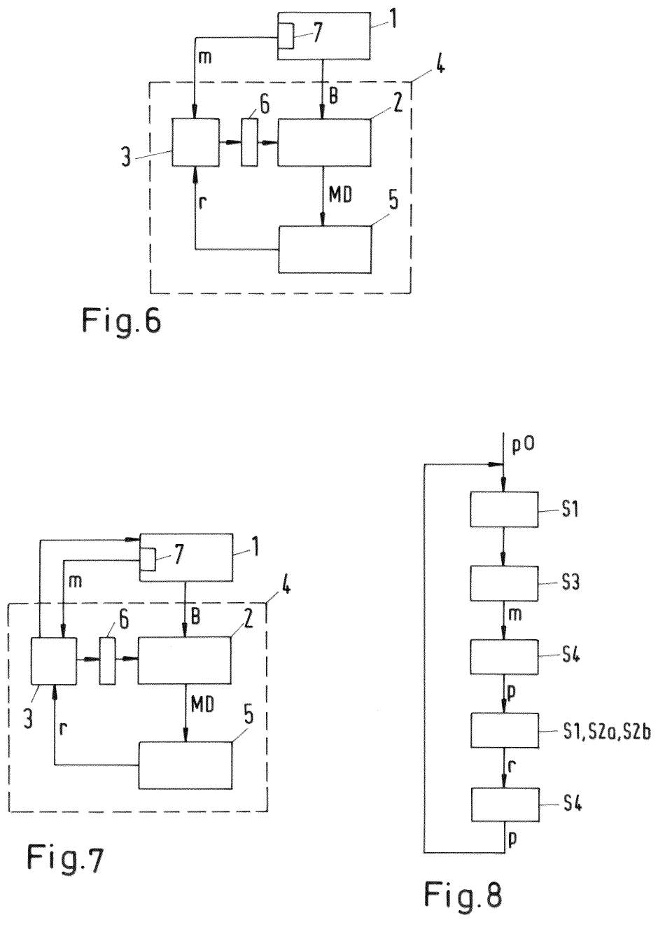

In an alternative to, or cumulatively with, the creation S2a of component-specific measurement data MD and the evaluation S2b, there can be a determination S3 of at least one production parameter m (see FIG. 6). Production parameters m are still explained in detail hereinbelow.

Further, there is an adaptation S4 of the at least one selection parameter p, p0 on the basis of the result r of the evaluation and/or on the basis of the production parameter m or a change in the production parameter m.

In this case, it is possible for the adaptation of the selection parameter p to be implemented in result-related but not production parameter-related fashion. Alternatively, it is possible for the adaptation S4 of the selection parameter p to be implemented in production parameter-related but not result-related fashion. It is also possible for the adaptation S4 to be both result-related and production parameter-related.

A result-related adaptation S4 may mean that the adaptation S4 is implemented if for example the result r
adopts a predetermined value,
deviates from a predetermined target value by more or not more than a predetermined amount, and/or
changes in a predetermined manner.

Additionally, a quality measure can be determined on the basis of the evaluation for a plurality or each of the components B of the selected components B, for example as a ratio between the number of the selected components which have passed a quality assessment on the basis of the evaluation and the overall number of the selected components, wherein the result-related adaptation S4 is implemented on the basis of the quality measure or its change.

A production parameter-related adaptation S4 may mean that the adaptation S4 is implemented if the production parameter m
adopts a predetermined value,
deviates from a predetermined target value by more or not more than a predetermined amount, and/or
changes or does not change in a predetermined manner, in particular during a predetermined time period.

Naturally, other result-related or production parameter-related adaptations S4 are also conceivable. In particular, it is conceivable that an adaptation is implemented even if the production parameter m does not change, or does not change by more than a predetermined amount, during a predetermined time period.

In particular, the production parameter-related adaptation can be implemented with a time offset. For example, the adaptation may be implemented only a predetermined period after a criterion for the adaptation has been satisfied. This has been explained hereinabove.

The selection parameter p being adapted may mean that a value is newly determined in this way, as a result of which, however, the current value of the selection parameter p need not necessarily be changed. However, it is naturally also possible for the value of the selection parameter p to change as a result of the adaptation S4. By way of example, the adaptation S4 can be implemented by virtue of a change in the currently set selection parameter p being determined and the adapted selection parameter p then being determined as the current selection parameter p which has been modified in accordance with the change.

It is possible for at least one measurement parameter to be determined in addition to the creation and evaluation S2a, S2b of component-specific measurement data MD or in addition to the determination S3 of the at least one production parameter m, wherein the adaptation of the at least one selection parameter is additionally implemented in measurement parameter-dependent fashion.

The adaptation S4 is implemented in automated fashion. To this end, the result r may form an input variable for an adaptation method, the output variable of which is an adapted selection parameter p. In an alternative, or cumulatively, the at least one production parameter p or its change may form an input variable for the method for adapting S4 the selection parameter p. In this respect, the explanations set out hereinabove regarding the adaptation S4 on the basis of the result r of the evaluation apply accordingly. An adapted selection parameter p can be determined by the adaptation method, for example a selection parameter p which is assigned to the input variable in accordance with a predetermined mapping or which arises from the input variable on account of a predetermined functional relationship.

The adaptation S4 is implemented in automated fashion, for example using an appropriate evaluation device 3 (see FIG. 6), which for example can be embodied as a microcontroller or integrated circuit or comprise one of these.

Further, the selection parameter p is adapted S4 in rule-based fashion. Rules R1, R2, Rn, Rn+1, Rm, Rm+1 are depicted in FIG. 2. A first rule represents a relationship or a mapping between a first value σ1 of a scatter and a rule-specific selection parameter pR1.

Thus, for example, a value of a scatter of a component-specific property can be determined as a resultant property as a result r of the evaluation of the measurement data MD, the property forming an input variable for the first rule R1. Thus, if this first value σ1 is determined, then there is an adaptation of the selection parameter p to the rule-specific output variable, which is to say the selection parameter pR1.

A second rule R2 represents a relationship between a second value of the scatter 62 and the selection parameter p. Thus, if this second value 62 is determined as a result r of the evaluation, then there is a mapping of the selection parameter p to the rule-specific output variable, which is to say the scatter-specific selection parameter pR2.

Consequently, one or more rules R1, R2 are able to represent a relationship between a plurality or even all of the possible values of a scatter and a scatter-dependent selection parameter p.

It is also possible for the rule to determine a change in the selection parameter p and for the adapted selection parameter p then to be determined by the change in the currently set selection parameter p in accordance with the change determined thus.

Also shown is a n-th rule Rn, which represents a relationship between a first production temperature T1 and a rule-specific selection parameter pRn. In this case, the first production temperature T1 forms a production parameter m. If the production temperature is detected to correspond to the first production temperature T1, then the selection parameter p is adapted to the corresponding output value pRn of the n-th rule. An n+1-th rule Rn+1 is likewise depicted. The latter correspondingly represents a relationship between a second production temperature T2 and a selection parameter pRn+1.

An m-th rule Rm is also depicted. Input variables of this m-th rule form an absolute value of a deviation between a first mean value μ1 of a component-specific property and a target value μsoll, and a time period between a current time t and a reference time to, for example the time of the last implemented adaptation S4 of the selection parameter p. If these two input variables adopt predetermined values, especially at the same time, then a rule-specific value pRm is determined as the output parameter and the currently set selection parameter p is adapted to this value.

Likewise depicted is an m+1-th rule Rm+1, the input variables of which are the absolute value of the explained deviation and the deviation between a number n(t) of components B produced at the current time t and a number n(t0) of components B produced at a certain time, for example the time of the last implemented adaptation. If these two input variables adopt predetermined values, especially at the same time, then the correspondingly rule-specific selection parameter pRm+1 can be set as adapted selection parameter p.

The rules R1, R2, Rn, Rn+1, Rm, Rm+1 depicted in FIG. 2 can for example be determined by machine learning, for example on the basis of an interpretive evaluation of the combination of already acquired or already determined production parameters m and the results r of the evaluation of measurement data MD, which were created by the coordinate measuring machine 2 when measuring the components B produced in accordance with these production parameters m. Further, it is possible for the depicted rules R1, R2, . . . , Rn, Rn+1, Rm, Rm+1 to be adapted, for example likewise by an interpretive evaluation of production parameters m and results r of the evaluation of measurement data MD, which were created by the application in accordance with existing rules R1, R2, Rn, Rn+1, Rm, Rm+1.

The rules R1, R2, Rn, Rn+1, Rm, Rm+1 depicted in FIG. 2 can be determined by machine learning methods. For example, it is possible to acquire and store both production parameters m and measurement data MD and/or results r of the evaluation of these measurement data MD over a predetermined period of time. Thereafter, in the set of data acquired thus, relationships between changes in the production parameters m and ensuing changes in the measurement data MD or in the results r can be analyzed, using data mining methods in particular. Further, it is then possible to determine selection parameters p which, for the results r setting-in, ensure a reliable and sufficiently accurate quality assessment for the produced components.

This determination can be implemented on the basis of a mapping known in advance. Thus, for example, selection parameters p may be assigned to certain results r of the evaluation, the selection parameters ensuring the reliable and sufficiently accurate quality assessment in the case of these measurement results.

Thus, for example, it is possible to determine whether a change in one or more production parameters m leads to an improvement in the quality of the components B produced, wherein an improvement can for example be detected whenever a deviation of a mean value of a component-specific variable from a target value is less than a predetermined amount and/or a scatter of a component-specific variable is smaller than a predetermined amount. Then, a selection parameter can be adapted accordingly, for example a sampling frequency can be reduced.

It is also possible, over a predetermined time period, to acquire and optionally store production parameters m, measurement data MD and/or results r of an evaluation of these measurement data MD and adaptations of the at least one selection parameter p carried out by a user. Then, a relationship between adaptations carried out by the user, the result r of the evaluation and/or the production parameter p or its change can be determined by evaluating this data set and can be used to determine the rules R1, R2, Rn, Rn+1, Rm, Rm+1 depicted in FIG. 2.

The input variables captured thus, which is to say production parameters, in particular set or given production parameters or changes in a production parameter, and output variables, which is to say the at least one selection parameter to be adjusted by the adaptation or its change, can—as explained hereinabove—form training data for determining a model by machine learning methods. This model can then be used to determine output variables for input variables that differ from the input variables of the training data.

The rules can be adapted accordingly. Thus, it is possible for example to detect whether a user subsequently changes a selection parameter p determined by a rule. The corresponding rule can be adapted if this is the case. By way of example, the model can be relearned or retrained.

FIG. 3a shows a schematic determination of a selection parameter p, which is determined on the basis of production parameters m, wherein the currently set selection parameter p can be adapted in such a way to the selection parameter p determined thus that the measurement S1 (see FIG. 1) can then be carried out in accordance with the adapted selection parameter p. Shown by way of example as production parameter m is a tool W used for the production. A production temperature T is a further production parameter m. A production time t is a further production parameter m, wherein, on the basis of the time, a production time period since a predetermined time t0 can be determined.

A further production parameter m is a number n of produced components B, wherein a number of components B produced since a predetermined time in particular can be determined on the basis of this number n.

Production air pressure D is a further production parameter m.

A further production parameter m is an ordinal number of a batch Cn, wherein a number of the batches C produced since a predetermined time in particular can be determined on the basis of this ordinal number (see FIG. 4).

A further production parameter m is a shift group S, for example an early shift, a day shift, a late shift or a night shift.

In this case, it is possible for the selection parameter p to be determined on the basis of exactly one of the illustrated production parameters m or on the basis of a plurality of the illustrated production parameters m. As an alternative, or cumulatively, it is possible for the selection parameter p to be determined on the basis of a change in exactly one of the illustrated production parameters m or on the basis of the changes in a plurality of the illustrated production parameters m.

Hence, the illustrated production parameters m may form input variables for determining, in particular in rule-based fashion, the selection parameter. The step of determining the production parameter(s) m is not depicted in FIG. 3b.

FIG. 3b depicts a determination of the selection parameter p on the basis of the measurement data MD, which were created by the measurement of components B selected in accordance with the set selection parameter p. In this case, the measurement data MD are evaluated S2b, and a result r of the evaluation is determined. Results r have already been explained hereinabove. The selection parameter p is then determined on the basis of this result r. This determination can likewise be implemented in rule-based fashion. Following the determination, the currently set selection parameter p can be adjusted to the value determined thus, whereby the adaptation is implemented.

In the embodiment depicted in FIG. 3a, it is for example possible for the selection parameter p to be adapted, for example to a predetermined value, or changed, in particular increased, by a predetermined value, at the k-th component B produced or measured since a predetermined time t0 (see FIG. 2).

It is also possible for the selection parameter p to be adapted, for example to a predetermined value, or changed, in particular increased, by a predetermined value, when the shift group S changes, which is to say in the case of a shift change.

It is also possible for the selection parameter p to be adapted, for example to a predetermined value, or changed, in particular increased, by a predetermined value, in each case after the expiry of predetermined time intervals, for example every 24 hours or every 48 hours.

It is also possible for the selection parameter p to be adapted, for example to a predetermined value, or changed, in particular increased, by a predetermined value, in the case of a tool change, a change in the batch C or in the case of a change in ambient conditions, for example the production temperature T or the production pressure D.

In the case of the determination and adaptation of the selection parameter illustrated in FIG. 3b, it is possible for the selection parameter p to be changed if it is determined that the properties of the produced components B or the development thereof over time, makes it possible to ensure a reliable quality assessment with a changed selection parameter p.

FIG. 4 shows an illustration of a selection of components B for measurement by a coordinate measuring machine 2. In this case, the components B were produced or manufactured, in particular at least partially manufactured, by a production device 1. What is illustrated here is that a batch Cn, Cn+1 comprises 10 components B, with only one component B per batch Cn, Cn+1 having been provided with a reference sign for reasons of clarity. An n-th batch Cn and an n+1-th batch Cn+1 are depicted. In this case, hatched components B represent selected components B, which should be measured by the coordinate measuring machine 2. What is illustrated here is that a sampling frequency for the n-th batch Cn is 5/10, with every second component B of the n-th batch Cn being measured.

The sampling frequency for the n+1-th batch Cn+1 is 3/10, with every fourth component B being measured.

Consequently, there was an adaptation S4 of the sampling frequency and the ordinal numbers of the components B to be selected in the sequence of produced components B of a batch Cn, Cn+1. FIG. 4 illustrates that the sampling frequency was reduced. However, it is naturally also conceivable for the sampling frequency to be increased in the case of a batch change.

FIG. 5 shows an illustration of components B to be selected in accordance with a further embodiment. In contrast with the embodiment illustrated in FIG. 4, the sampling frequencies for the n-th and the n+1-th batch Cn, Cn+1 are the same. However, the ordinal numbers of the components B to be measured differ in the sequence of produced components B of a batch Cn, Cn+1. Thus, the first, the third, the fifth, the seventh and the ninth component B of the n-th batch Cn are selected in the various embodiment depicted in FIG. 4 while the first, the second, the fourth, the seventh and the tenth component B are selected in the various embodiment depicted in FIG. 5. Further, the first, the fifth and the ninth component of the n+1-th batch Cn+1 are selected in the various embodiment depicted in FIG. 4, while the first, the fourth and the eighth component B are selected in the various embodiment depicted in FIG. 5.

FIG. 6 shows a block diagram of a system 4 according to the invention for measuring a plurality of components B (see FIG. 4). The system comprises a coordinate measuring machine 2 and an evaluation and control device, which comprises an evaluation module 5, a planning module 3 and a control module 6 or which is formed by these modules. Also depicted is a production device 1, which may likewise be part of the system 4, although this is not necessary. A device 7 for determining a production parameter m, for example a sensor, is likewise depicted. A transport device for transporting produced components B to the coordinate measuring machine 2 is not depicted here.

All or selected produced components B are supplied to the coordinate measuring machine 2, for example via the transport device (not depicted here).

The selected components B are then measured by the coordinate measuring machine 2, with measurement data MD being created. Thus, if all produced components B are supplied to the coordinate measuring machine 2, then only selected components B are measured.

These measurement data MD are transferred from the coordinate measuring machine 2 to the evaluation module 5. To this end, the coordinate measuring machine 2 can be data-connected and/or signal-connected to the evaluation module 5. The evaluation module 5 can carry out a statistical evaluation of the determined measurement data MD in particular. By way of example, as explained hereinabove, the evaluation module 5 can determine a mean μ1 and/or a scatter σ of component-specific variables of the measured components B as a result r of the evaluation.

Such a result r can then be transmitted to the planning module 3. To this end, the evaluation module 5 can be data-connected and/or signal-connected to the planning module 3. The planning module 3 can then carry out an adaptation S4 of the at least one selection parameter p (see FIG. 1) on the basis of the result r.

By way of example, the planning module 3 can determine an adapted measurement strategy for measuring the multiplicity of produced components B. Then, a control module 6 can control the selection and measurement of components B on the basis of this measurement strategy, for example by controlling the transport device (not illustrated) and/or the coordinate measuring machine 6. To this end, the planning module 3 can be data-connected and/or signal-connected to the control module 6. The measurement strategy thus defines the number of components B, and optionally also which of the components B, are selected from the sequence of produced components B for the measurement by the coordinate measuring machine 2. However, the measurement strategy can also define a component-specific test plan, whereby, in particular, the sensor to be used, the travel of the sensor to be used for the measurement and the component-specific measurement strategy are defined.

It is also possible for the evaluation module 5 to be integrated into the planning module 3 or for both modules 3, 5 to be embodied as a joint module. It is also conceivable for the evaluation module 5 to carry out the adaptation S4 of the one selection parameter p on the basis of the result r, wherein this selection parameter p is then transferred to the planning module 3 and the latter then determines the adapted measurement strategy.

It is also depicted that the device 7 for determining a production parameter m is likewise data-connected and/or signal-connected to the planning module 3. The planning module 3 can consequently carry out an adaptation of the at least one selection parameter p, also on the basis of the production parameter m or its change, and determine an adapted measurement strategy.

It is naturally also conceivable for the device 7 for determining a production parameter m to likewise be data-connected and/or signal-connected to the evaluation module 5 and for the device to transmit the production parameter m to this module 5, which can then carry out an adaptation of the at least one selection parameter p also on the basis of the production parameter m or its change and which then transfers this selection parameter p—as explained hereinabove—to the planning module 3.

FIG. 7 shows a schematic block diagram of a system 4 according to the invention in a further embodiment. What is shown in contrast to the embodiment illustrated in FIG. 6 is that the planning module 3 also can adapt at least one production parameter p for the production of the components B by the production device 1, in addition to the adaptation S4 of the at least one selection parameter p (see FIG. 1) on the basis of the result r of the evaluation and/or on the basis of the production parameter m or its change. To this end, the planning module 3 can for example determine suitable control commands for a device for adjusting a target value of a production parameter, for example a production temperature or production pressure, or of a tool W to be used for the production, the control commands then adjusting the production parameter to the corresponding target value. The adjustment of the production parameter m by the planning module can be implemented in result-related fashion, in particular in purely result-related fashion, which is to say on the basis of a value or a change in the result r of the evaluation. This can advantageously implement a timely change to the production process in order to ensure a quality of the produced components B.

In this case, the planning module 3, the evaluation module 5 and the control module 6 can each comprise a computing device or data processing device, which may for example be designed as a microcontroller or integrated circuit or comprise one of these. However, it is naturally also possible for the functionalities of the modules to be provided by a common computing device or data processing device.

FIG. 8 shows a schematic flowchart of a method according to the invention in a further embodiment. In accordance with the embodiment depicted in FIG. 1, there is a selection S1 of components to be measured from a multiplicity of components B in accordance with an initial selection parameter p0. Further, there is a determination S3 of at least one production parameter m and an adaptation S4 of the at least one selection parameter p on the basis of the production parameter m or its change. Consequently, the adaptation is implemented in purely production parameter-related fashion and not in result-related fashion.

Further, this purely production parameter-related adaptation S4 is followed by a selection S1 in accordance with the selection parameter p which has been adapted in production parameter-related fashion, wherein there then is a creation S2a of component-specific measurement data MD by measuring the correspondingly selected components B using a coordinate measuring machine 2 (see FIG. 6) and an evaluation S2b of the measurement data MD. Further, an adaptation S4 of the at least one selection parameter p is then implemented on the basis of the result r of the evaluation. The adaptation is implemented in purely result-related fashion and not in production parameter-related fashion. This is followed by a selection S1 in accordance with the adapted selection parameter p.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

### LIST OF REFERENCE SIGNS

1 Production device
2 Coordinate measuring machine
3 Planning module
4 System
5 Evaluation module
6 Control module
7 Determination device
S1 Select
S2a Create
S2b Analyze
S3 Determine at least one production parameter
S4 Adapt
p Selection parameter
p0 Initial selection parameter
m Production parameter
r Result of the evaluation
σ1, σ2 Scatters
T, T1, T2 Production temperature
μ1 Mean
μsoll Target mean
t Time
t0 Predetermined time
n(t) Number
n(t0) Number
R1, R2, Rn, Rn+1, Rm, Rm+1 Rule
p_{R1}, p_{R2}, p_{Rn}, p_{Rn+1}, p_{Rm}, p_{Rm+1} Rule-specific selection parameter
W Tool
n Number
D Production pressure
S Shift group
Cn n-th Batch
Cn+1 n+1-th Batch
B Component

1-15. (canceled)

16. A method for measuring components produced by a production device, the method comprising:
selecting components to be measured from a plurality of components, the selection being made according to at least one selection parameter, wherein the at least one selection parameter includes a sampling frequency;
determining at least one production parameter, wherein the at least one production parameter includes a production condition; and
adapting the sampling frequency based on the production parameter or a change in the production parameter, including reducing the sampling frequency in response to one or more production parameters not changing by more than a predetermined amount.

17. The method of claim 16 wherein the at least one selection parameter is at least one ordinal number in a sequence of produced components.

18. The method of claim 16 further comprising:
determining at least one measurement parameter,
wherein the at least one selection parameter is adapted based on the measurement parameter or a change in the measurement parameter.

19. The method of claim 16 wherein the at least one selection parameter is adapted in partly or fully automated fashion.

20. The method of claim 19 wherein the selection parameter is adapted based on rules.

21. The method of claim 20 wherein the rules are determined by machine learning.

22. The method of claim 16 wherein the at least one production parameter is or represents at least one of an ambient condition, a tool used for the production, a method used for the production, a number of the components produced since a certain time, a production time period since a certain time, a number of batches produced since a certain time or a shift group.

23. The method of claim 16 wherein a measurement parameter is or represents a sensor used for the measurement.

24. The method of claim 16 wherein the at least one selection parameter is at least one ordinal number in a sequence of produced components.

25. The method of claim 16 wherein:
the components to be measured are selected from a batch of components; and
the components to be measured are selected from a further batch of components in accordance with the adapted selection parameter.

26. The method of claim 16 wherein:
at least one quality measure is determined for the selected components by evaluation; and
adaptation of the at least one selection parameter is implemented based on the quality measure or a change in the quality measure.

27. The method of claim 16 wherein:
at least one component-specific property is determined for components of the selected components by evaluation; and
at least one of:
an adaptation is implemented in response to the component-specific property deviating by more or less than a predetermined amount from a target value for a predetermined number of the measured components or in response to the component-specific property changing by more or less than a predetermined amount, or
at least one resultant property is determined based on the component-specific properties, wherein an adaptation is implemented in response to the resultant property deviating by more or less than a predetermined amount from a target value or in response to the resultant property changing by more or less than a predetermined amount.

28. The method of claim 16 further comprising performing, following determining the at least one production parameter, at least one of:
setting the selection parameter to a value assigned to the production parameter or to the change in the production parameter, or
changing the selection parameter and assigning the change to the production parameter or the change in the production parameter.

29. The method of claim 16 further comprising, following a purely production-parameter-related adaptation of the at least one selection parameter:
selecting components to be measured from a predetermined number of components, selecting being made in accordance with the selection parameter that has been adapted in production-parameter-related fashion,
creating a component-specific measurement data by measuring the selected components using a coordinate measuring machine and the analysis of analyzing the measurement data, and
renewing a purely result-related adaptation of the at least one selection parameter based on a result of evaluating.

30. A method for measuring components produced by a production device, the method comprising:
selecting components to be measured from a plurality of components, the selection is made according to at least one selection parameter,
determining at least one production parameter, and
adapting at least one selection parameter based on the production parameter or a change in the production parameter, wherein:
the production-parameter-related adaptation is implemented with a time offset, and
the production-parameter-related adaptation is implemented at a time at which the component produced using the production parameter is measured.

31. The method of claim 30 further comprising:
creating component-specific measurement data by measuring selected components using a coordinate measuring machine and an evaluation of the measurement data,
wherein the adaptation of the at least one selection parameter is additionally implemented based on a result of the evaluation.

32. The method of claim 30 wherein the selection parameter is a sampling frequency.

33. A non-transitory computer-readable medium comprising instructions including:
selecting components to be measured from a plurality of components, the selection being made according to at least one selection parameter,
determining at least one production parameter, and
adapting the at least one selection parameter based on the production parameter or a change in the production parameter,
wherein:
the production-parameter-related adaptation is implemented with a time offset, and
the adaptation of the selection parameter is implemented at a time at which the component produced using the production parameter is measured.

34. A method for measuring components produced by a production device, the method comprising:
selecting components to be measured from a plurality of components, wherein selecting is according to at least one selection parameter,
determining at least one production parameter,
adapting the at least one selection parameter on a basis of the production parameter or a change in the production parameter,
selecting components to be measured from a predetermined number of components, wherein selecting is accordance with the selection parameter that has been adapted in production-parameter-related fashion,
creating component-specific measurement data by measuring the components selected in accordance with selecting components to be measured from a predetermined number of components using a coordinate measuring machine and analysis of the measurement data, and
renewing a purely result-related adaptation of the at least one selection parameter based on a result of an evaluation in accordance with creating component-specific measurement data.

35. A system for measuring components produced by a production device, the system comprising:
at least one coordinate measuring machine; and
at least one evaluation and control device, wherein the system is configured to carry out a measurement method including:
selecting components to be measured from a plurality of components, wherein selecting in accordance to at least one selection parameter,
determining at least one production parameter, and
adapting at least one selection parameter on a basis of the production parameter or a change in the production parameter, wherein:
the adapting is implemented with a time offset, and
the adapting the at least one selection parameter is implemented at a time at that the component produced using the production parameter is measured.
